(19) United States
(12) Patent Application Publication
(10) Pub. No.: US 2016/0356924 A1
(43) Pub. Date: Dec. 8, 2016

(54) LENS COMPOSITION THAT FILTERS OUT AND REDUCES TRANSMITTANCE OF BLUE LIGHT AND LENS FORMED OF SAME

(71) Applicants: KUO-LIANG CHEN, Taoyuan City (TW); HSI-LIANG LIN, Taipei City (TW); CHAO-YUNG CHAN, Taipei City (TW); YEN-HUEI WEN, Miaoli County (TW)

(72) Inventor: KUO-LIANG CHEN, Taoyuan City (TW)

(21) Appl. No.: 14/727,877

(22) Filed: Jun. 2, 2015

(51) Int. Cl. G02B 1/04; B29D 11/00; F21V 9/16; G02C 7/10; F21V 13/02

(52) U.S. Cl. CPC G02B 1/041; G02C 7/108; F21V 13/02; F21V 9/16; G02C 7/104; B29D 11/00009; B29K 2101/12

(57) ABSTRACT

Provided are a lens composition that filters out and reduces transmittance of blue light and a lens formed of the composition. The lens composition includes: 40-50% thermoplastic material, 34-46% plasticizer, 2.6-4.4% quinophthalone, 2.1-3.6% perynone, 1.3-2.3% anthraquinone, and 0.48-0.82% luminophor. The lens is formed by having the composition mixed and subjected to pressing or injection molding so that the lens reduces the transmittance of blue light in the wavelength range of 380-550 nm to about 35-65% thereby reducing the harm caused thereby to human eyes.

### TECHNICAL FIELD OF THE INVENTION

The present invention relates generally to a lens composition that filters out and reduces transmittance of blue light and a lens formed of the composition, and more particularly to a lens composition that comprises the ingredients of quinophthalone, perynone, anthraquinone, and a luminophor.

### DESCRIPTION OF THE PRIOR ART

The electronic technology brings modern people with conveniences and ease of living and, despite suiting fundamental needs of living, has also been widely applied to multimedia entertainment. However, due to the wide applications, users have spent more and more time everyday in watching screens. Light projecting from electronic screens contains components that are harmful to the human beings, such as blue light. After having been long irradiated with blue light, the eyes of the users are readily damaged, causing undesired influence on health.

For such causes, heretofore, some techniques are available by depositing a light-filtering coating material on a light emission element in order to achieve a purpose of lowering the transmittance of harmful light.

In general applications, such coating material must be attached to a light transmittable substrate through a proper way of coating and effective reduction of harmful light is determined by the thickness of the material coated. Such applications requires, in manufacturing processes thereof, the light-transmittable substrate be formed first, and then coating can be conducted on the substrate. This increases the manufacturing costs and additional operations of quality inspection of the light filter layer so coated must be performed. This causes difficult and troubles to the manufacturing. Further, the light filter layer coated on a surface of the light transmittable substrate is readily peeled and/or scratched due to undesired contact and rubbing with external objects and this affects the quality thereof. Further improvements are obviously necessary.

In view of such problems, the present invention aims to provide a lens composition that filters out and reduces transmittance of blue light and a lens formed of the composition, of which details will be described as the present invention.

### SUMMARY OF THE INVENTION

An object of the preset invention is to provide a lens composition that filters out and reduces transmittance of blue light and a lens formed of the composition, wherein a composition that is directly mixed in a lens during a process of forming the lens so that the lens itself possesses effectiveness of filtering out blue light and reducing the transmittance of blue light and no additional processing operations are needed for a light filtering coating layer thereby simplifying the manufacturing process, lowering down manufacturing costs and eliminating the drawbacks of peeling and scratching.

The present invention provides a lens composition that filters out and reduces transmittance of blue light. The lens composition comprises: 40-50% thermoplastic material, 34-46% plasticizer, 2.6-4.4% quinophthalone, 2.1-3.6% perynone, 1.3-2.3% anthraquinone, and 0.48-0.82% luminophor.

The thermoplastic material comprises one of polycarbonate (PC), polyethylene terephthalate (PET), polyethylene terephthalate glycol-modified (PETG), and poly(methyl methacrylate) (PMMA).

The lens composition of the present invention, after being mixed, can be shaped through hot pressing molding or injection molding, to form a lens for an electronic product screen, a lens of eyeglasses, a mask lens of helmets, or light projecting lens of other light emission element, but not limited to such applications.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a curve of transmittance of a lens according to the present invention for wavelength between 380-550 nm.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

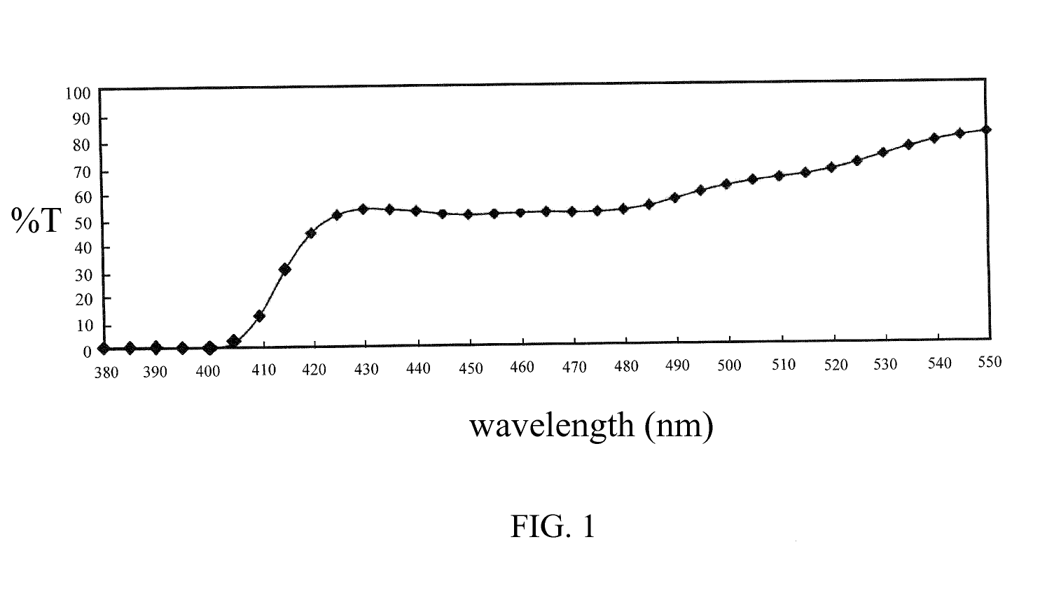

Referring to FIGS. 1 and 2, the present invention provides a lens composition that filters out and reduces transmittance of blue light and comprises 40-50% thermoplastic material, 34-46% plasticizer, 2.6-4.4% quinophthalone, 2.1-3.6% perynone, 1.3-2.3% anthraquinone, and 0.48-0.82% luminophor. Two preferred examples of embodying the present invention will be descried hereinafter for the constituent component ratios given above.

### EXAMPLE 1

A lens composition of the present invention comprises 48% thermoplastic material, 43% plasticizer, 3.8% quinophthalone, 2.7% perynone, 1.8% anthraquinone, and 0.7% luminophor, which are mixed and subject to hot pressing molding to be shaped as a lens. The lens has been subjected to test and inspection using a transmittance spectrometer, of which the model number if HITACHI/U-4100 and the result of inspection reveals the transmittance of the lens with respect to wavelength in the range of 380-550 nm, which result is listed in the following table:

| wavelength (nm) | transmittance (%) |
|---|---|
| 380 | 0.01 |
| 385 | 0.01 |
| 390 | 0.02 |
| 395 | 0.02 |
| 400 | 0.07 |
| 405 | 1.85 |
| 410 | 12.73 |
| 415 | 30.83 |
| 420 | 45.20 |
| 425 | 52.24 |
| 430 | 54.62 |
| 435 | 54.38 |
| 440 | 53.73 |
| 445 | 52.68 |
| 450 | 52.22 |
| 455 | 52.59 |
| 460 | 52.98 |
| 465 | 53.29 |
| 470 | 53.20 |
| 475 | 53.44 |
| 480 | 54.23 |
| 485 | 55.90 |
| 490 | 58.54 |
| 495 | 61.37 |
| 500 | 63.73 |
| 505 | 65.59 |
| 510 | 66.97 |
| 515 | 68.30 |
| 520 | 70.27 |
| 525 | 72.93 |
| 530 | 76.14 |
| 535 | 79.20 |
| 540 | 81.79 |
| 545 | 83.66 |
| 550 | 85.04 |

In the above test, the lens of the present invention provides an average light transmittance of 50.16. This indicates the lens can effectively protect human eyes from being damaged. It is noted here that the light transmittance of the lens of the present invention approaches zero for the wavelength range 380-400 nm for blue light close to ultraviolet light. In other words, the present invention can effectively and completely filter out light of the wavelength range of 380-400 nm. The wavelength of this range generally belongs to harmful light. Thus, the present invention can effectively protect a user from being damaged. The effectiveness of the present invention is prominent.

### EXAMPLE 2

A lens composition of the present invention comprises 47% thermoplastic material, 42.8% plasticizer, 4.2% quinophthalone, 3.3% perynone, 1.9% anthraquinone, and 0.8% luminophor, which are mixed and subject to hot pressing molding to be shaped as a lens. The lens has been subjected to test and inspection and the results of tests indicate the average light transmittance in the wavelength 380-550 nm is 48.5%. It is quite apparent that the present invention has an excellent effect in reducing the transmittance of blue light that is harmful

In the lens composition disclosed in the present invention, the luminophor may comprise components of rare earth elements. The luminophor may comprise manganese ions.

The lens that is capable of filtering out and reducing transmittance of blue light according to the present invention, after being molded through hot pressing, may be further subjected to cutting and/or grinding so as to form a lens having an outer contour that is fit to an opening formed in an eyeglasses frame so that the lens is mountable to the opening of the eyeglasses frame to serve as an eyeglasses lens. Alternatively, after being formed through hot pressing, the lens can be shaped like a visor or a mask of a working helmet or a motorcycle/bicycle helmet, a flat lens, a thin-film like flat lens, a light projection lens of a light emission element, or a protective film attachable to a screen of an electronic product; however, the present invention is not limited to such applications.

The lens composition that filters out and reduces transmittance of blue light is directly mixed with a base material of a lens to make the lens so that there is no need for an additional operation of coating. As such, the present invention shows the following advantages:

(1) The manufacturing process of a lens can be simplified and the manufacturing cost is reduced.

(2) No filtering coating layer will be peeled or scratched by an external force.

(3) All the constituent components are mixed together and then subjected to hot pressing or injection molding so that there is no need to coat a filtering coating layer. The quality of the lens so produced is stable thereby product quality and yield rate can be enhanced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A lens composition that filters out and reduces transmittance of blue light, comprising: 40-50% thermoplastic material, 34-46% plasticizer, 2.6-4.4% quinophthalone, 2.1-3.6% perynone, 1.3-2.3% anthraquinone, and 0.48-0.82% luminophor.

2. The lens composition according to claim 1, comprising: 48% thermoplastic material, 43% plasticizer, 3.8% quinophthalone, 2.7% perynone, 1.8% anthraquinone, and 0.7% luminophor.

3. The lens composition according to claim 1, wherein the thermoplastic material comprises one of polycarbonate (PC), polyethylene terephthalate (PET), polyethylene terephthalate glycol-modified (PETG), and poly(methyl methacrylate) (PMMA).

4. The lens composition according to claim 2, wherein the thermoplastic material comprises one of polycarbonate (PC), polyethylene terephthalate (PET), polyethylene terephthalate glycol-modified (PETG), and poly(methyl methacrylate) (PMMA).

5. A lens, which is formed by having the lens composition of claim 1 mixed and subjected to hot pressing or injection molding.

6. A lens, which is formed by having the lens composition of claim 2 mixed and subjected to hot pressing or injection molding.

7. The lens according to claim 5, which comprise an outer contour fit to an opening of an eyeglasses frame.

8. The lens according to claim 6, which comprise an outer contour fit to an opening of an eyeglasses frame.

9. The lens according to claim 5, which is formed as a visor or mask of a helmet or a light projection lens of a light emission element.

10. The lens according to claim 6, which is formed as a visor or mask of a helmet or a light projection lens of a light emission element.

11. The lens according to claim 5, which is formed as a flat lens.

12. The lens according to claim 6, which is formed as a flat lens.

13. The lens according to claim 5, which is formed as a thin-film like flat lens.

14. The lens according to claim 6, which is formed as a thin-film like flat lens.

15. The lens composition according to claim 1, wherein the luminophor comprises a rare earth element.

16. The lens composition according to claim 2, wherein the luminophor comprises a rare earth element.

17. The lens composition according to claim 1, wherein the luminophor comprises manganese ions.

18. The lens composition according to claim 2, wherein the luminophor comprises manganese ions.
